(19) United States
(12) Patent Application Publication
(10) Pub. No.: US 2002/0043141 A1
(43) Pub. Date: Apr. 18, 2002

(54) Cutting device

(76) Inventors: Iain Bradfield, Burton-on-Trent (GB); Paul Steabben Hepworth, Surrey (GB)

Correspondence Address: NIKOLAI & MERSEREAU, P.A., SUITE 820, 900 SECOND AVENUE SOUTH, MINNEAPOLIS, MN, 55402-3813, US

(21) Appl. No.: 09/952,402

(22) Filed: Sep. 14, 2001

(30) Foreign Application Priority Data
Jan. 19, 2001 (GB) PCT/GB01/00190
Jan. 20, 2000 (GB) GB0001173.4

(51) Int. Cl. B26D 1/25

(52) U.S. Cl. 83/605; 83/471.3; 83/564

(57) ABSTRACT

A cutting device for producing an end cut in an elongate article (10), the cutting device including a handle (12) movably mounted on a base (11) and a support table (40) mounted on said base (11), the support table (40) having an upwardly facing support surface (SF) on which an article (10) to be cut may be mounted, and a cutting assembly (CA) including a disposable cutting blade (38), the cutting assembly (CA) being detachably mounted on said handle (12) to enable replacement of said blade (38).

The present invention relates to a cutting device intended for producing end cuts in an elongate article such as a plastics edging trim as may be used to edge tiled surfaces.

According to one aspect of the present invention there is provided a cutting device for producing an end cut in an elongate article, the cutting device including a handle movably mounted on a base and a support table mounted on said base, the support table having an upwardly facing support surface on which an article to be cut may be mounted, and a cutting assembly including a disposable cutting blade, the cutting assembly being detachably mounted on said handle to enable replacement of said blade.

Various aspects of the present invention are hereinafter described, with reference to the accompanying drawings in which:

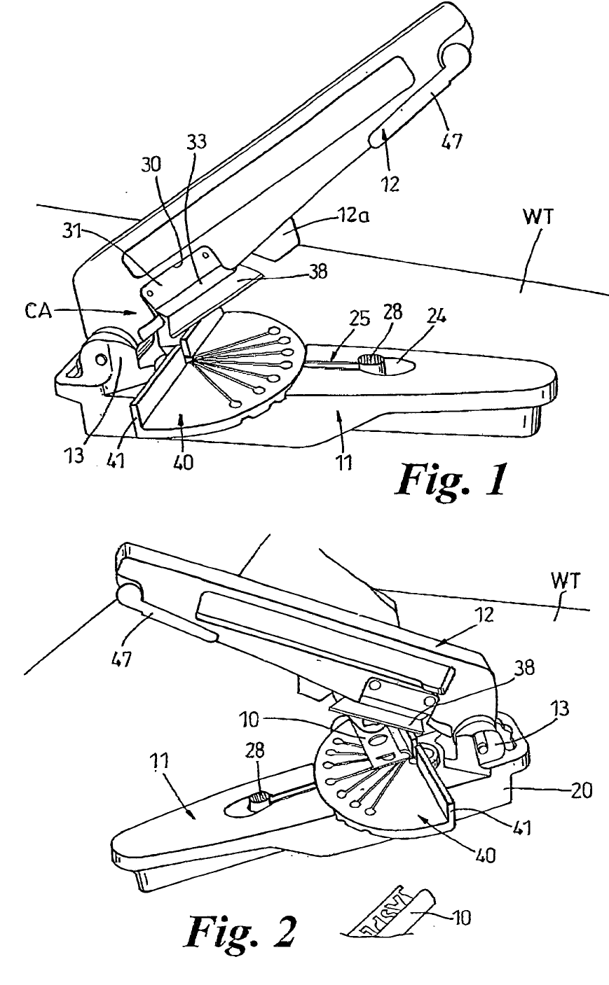

FIG. 1 is a perspective view of a first embodiment according to the present invention;

FIG. 2 is a perspective view of the first embodiment shown in use;

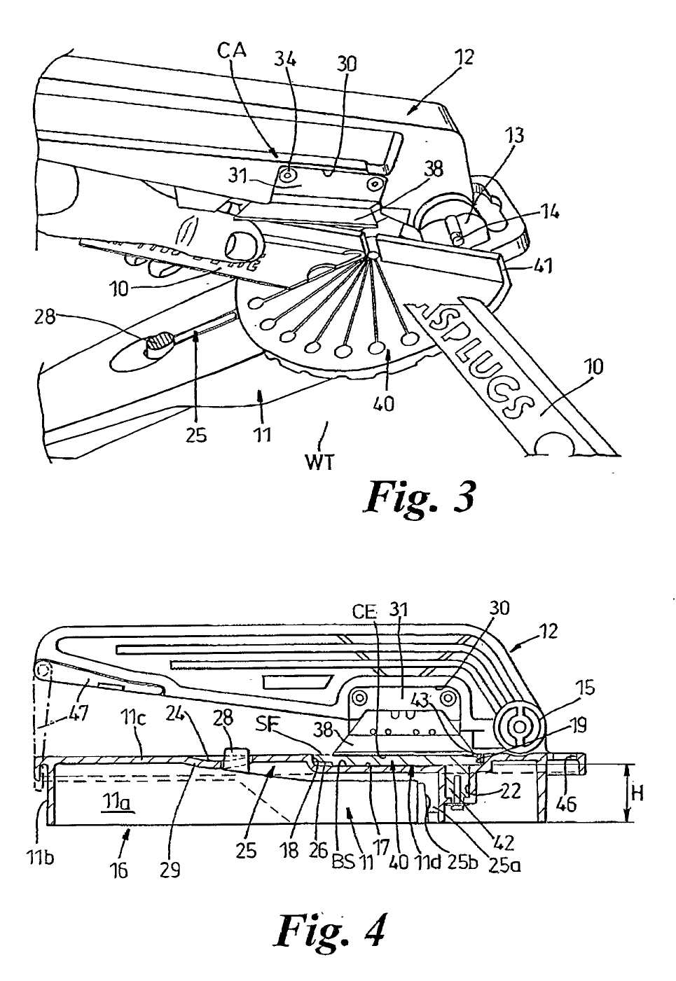

FIG. 3 is a similar view to FIG. 2 showing the first embodiment in a different functional position when in use;

FIG. 4 is a side view, partly in section, of the first embodiment;

FIG. 5 is a plan view from below of the first embodiment;

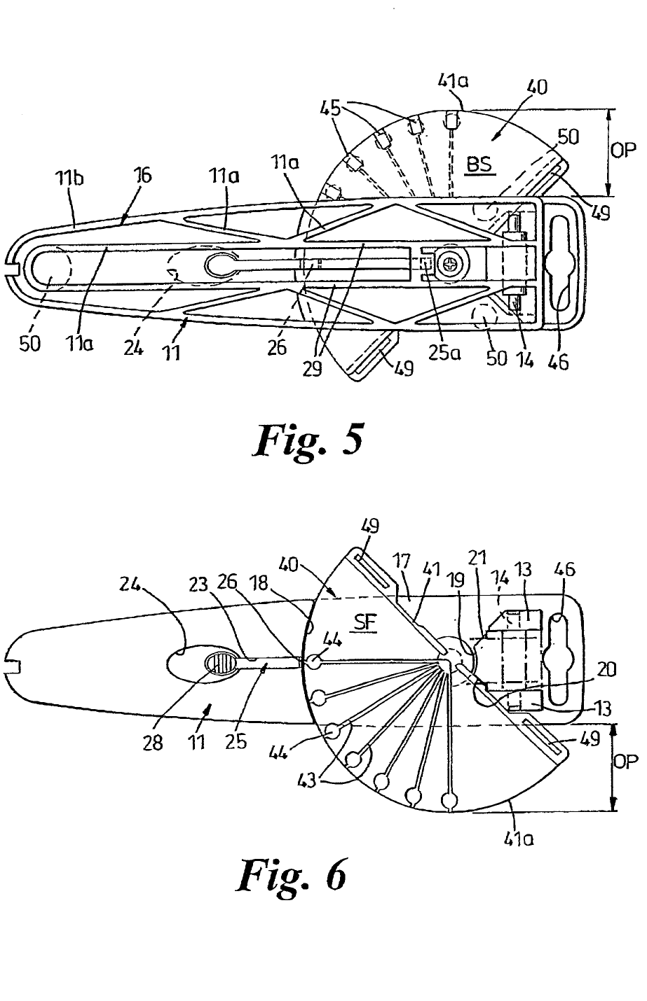

FIG. 6 is a plan view from above of the first embodiment with its handle removed;

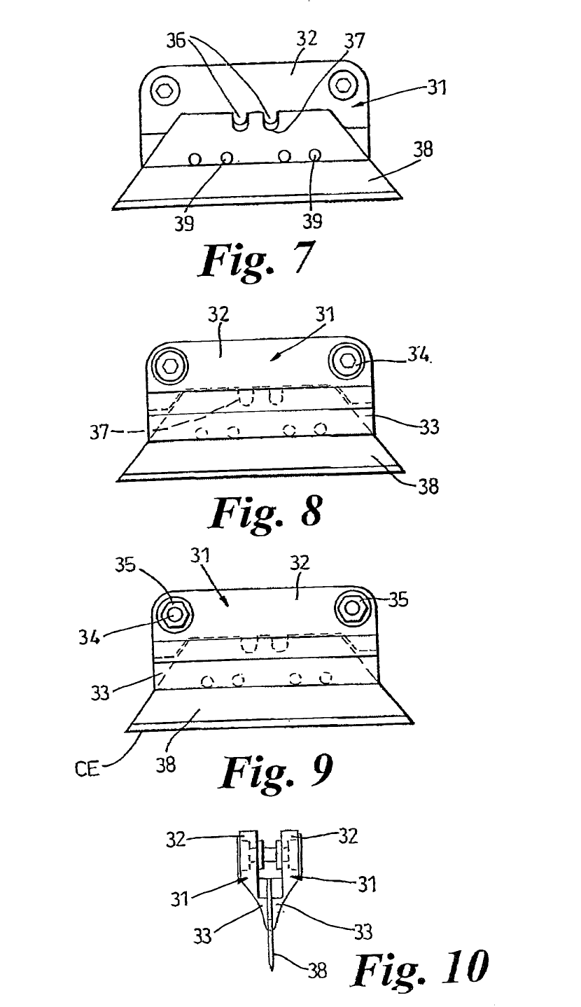

FIG. 7 is a side view of a cutting assembly of the first embodiment with one side casting removed;

FIG. 8 is a side view opposite to that of FIG. 7;

FIG. 9 is a side view similar to that of FIG. 7 with the side casting in place;

FIG. 10 is an end view of the cutting assembly of FIG. 9;

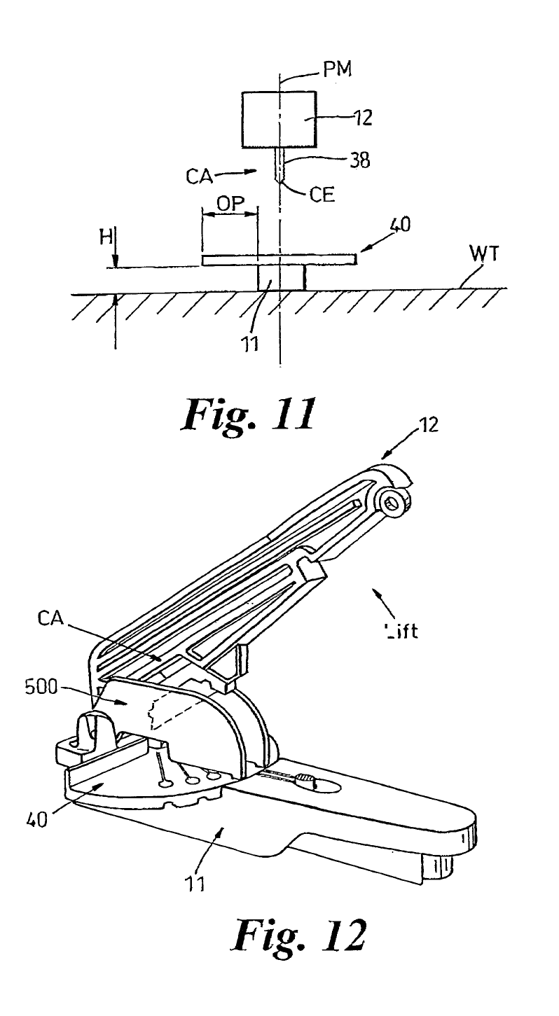

FIG. 11 is a schematic end view of the first embodiment,

FIG. 12 is a perspective view of a second embodiment according to the present invention;

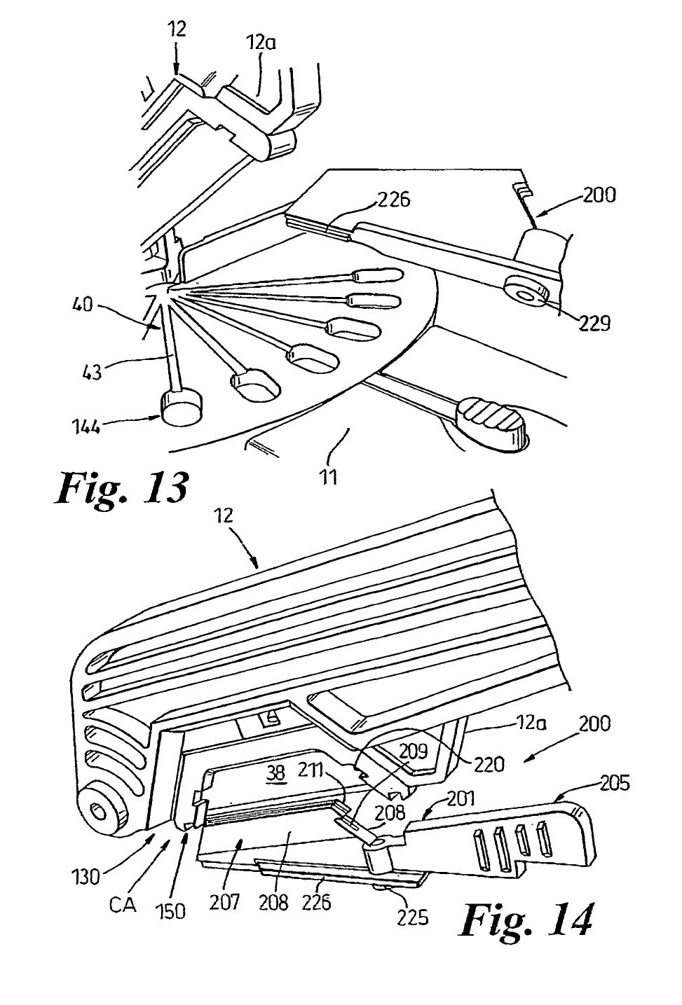

FIG. 13 is an enlarged, part, perspective view of the second embodiment;

FIG. 14 is an enlarged part perspective view of the handle of the second embodiment shown together with a blade removal tool;

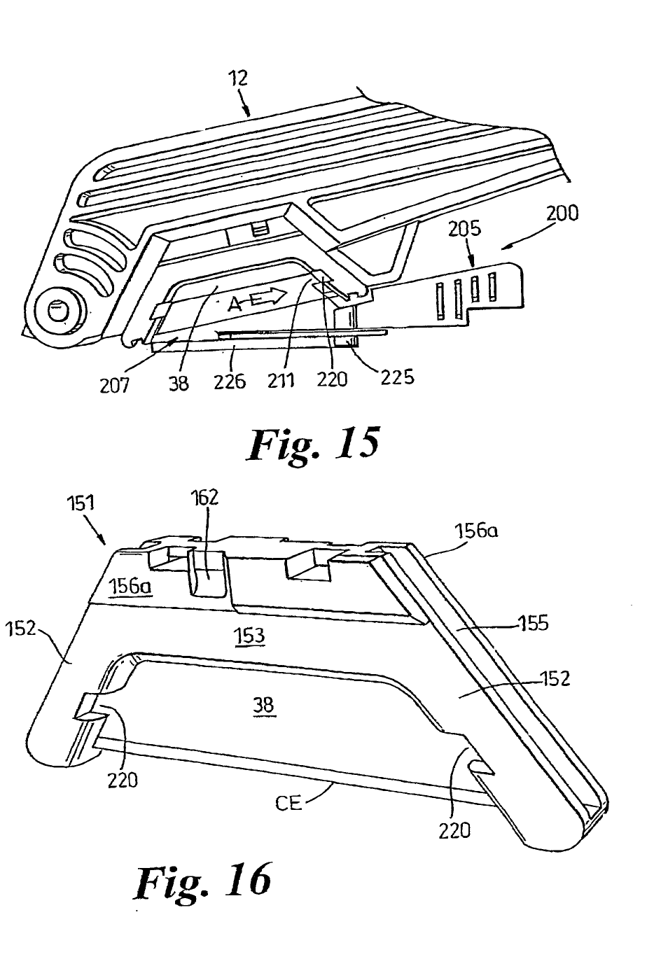

FIG. 15 is a side view of the combination shown in FIG. 14 with the handle and blade removal tool in a different relative operating position;

FIG. 16 is a perspective view of a cutting assembly of the second embodiment;

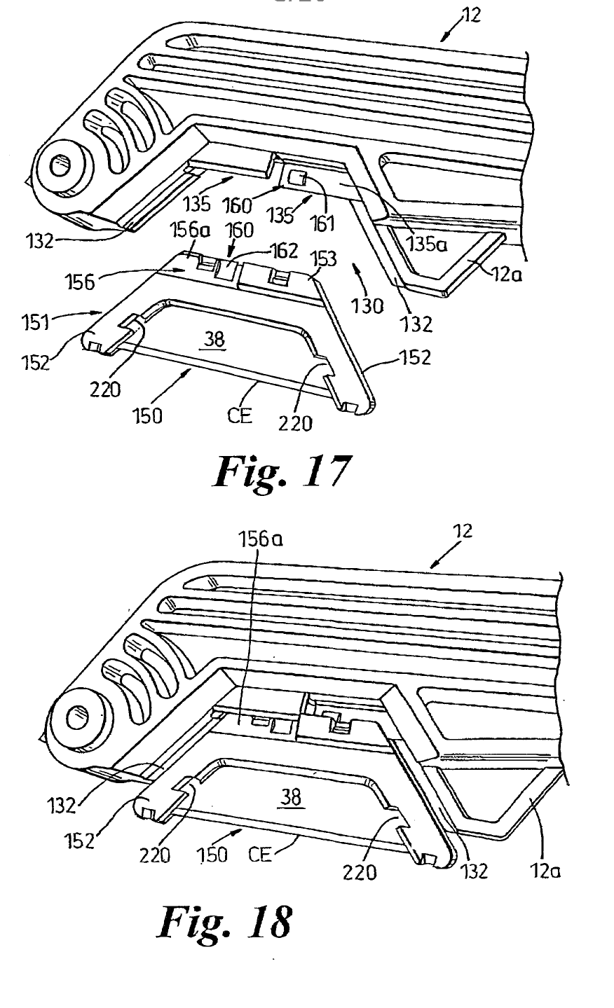

FIG. 17 is a perspective view of the handle and cutting assembly of the second embodiment shown fully separated;

FIG. 18 is a view similar to that of FIG. 17 with the handle and cutting assembly shown partially separated;

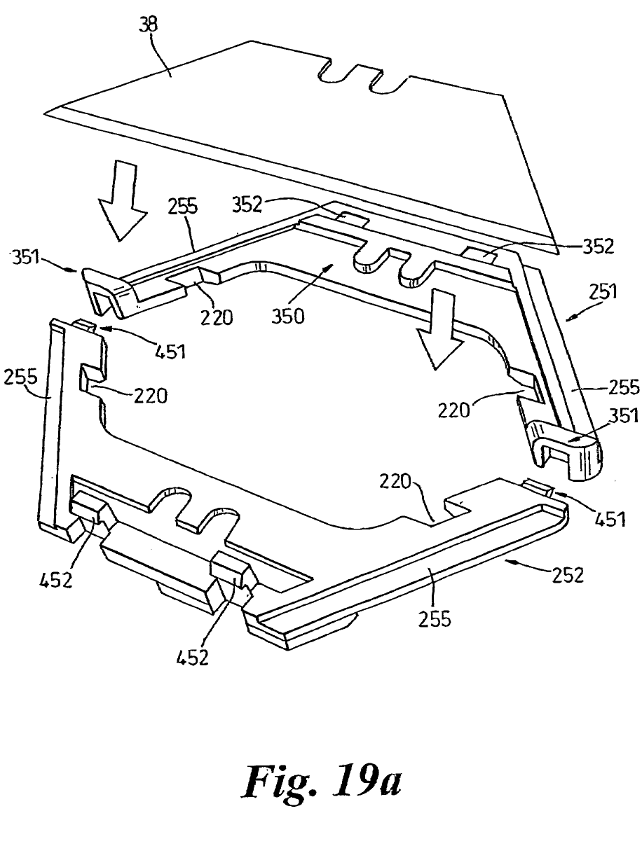

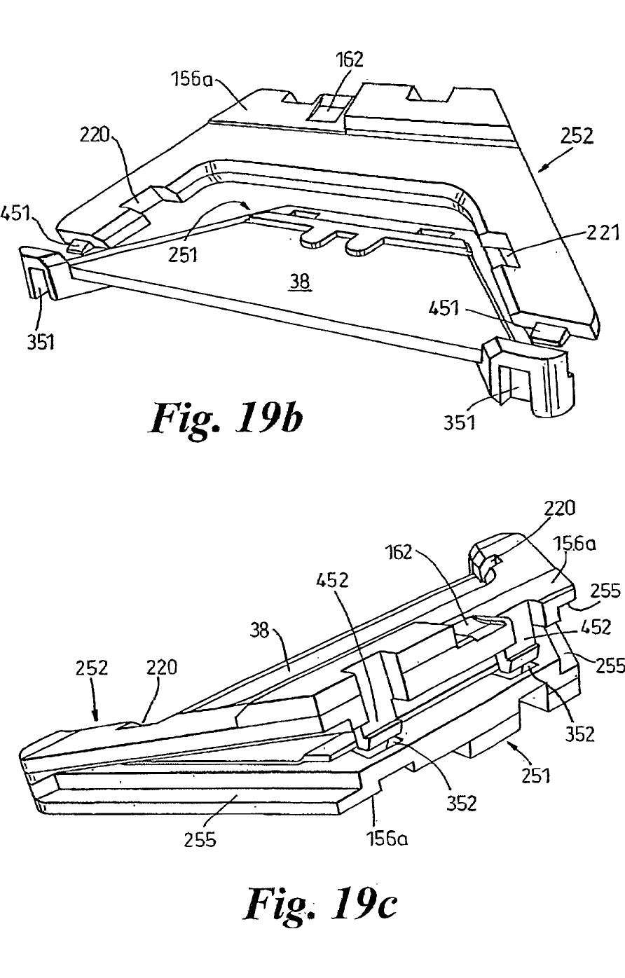

FIGS. 19a to 19c are perspective views of the cutting assembly shown at different stages during assembly.

The two embodiments of the cutting device shown in the figures is generally in the form of a hand-operated guillotine intended to be free standing and operated on a work surface WT (such as a table or bench top). It is principally intended for producing clean and accurate end cuts in plastics edging trim 10 often used to edge tiled surfaces. It will be appreciated however that the cutting device of the present invention may be used to cut to length any suitable elongate article which can be accommodated by the device. An example of a typical trim 10 is shown in FIGS. 2 and 3 of the drawings, from which it can be seen that the trim which is in the form of an elongated strip, has a flat base part at one edge of which is integrally formed an upstanding, arcuate lip which is spaced from, but extends back over, the base.

The cutting device for both embodiments basically comprises a base member 11 on which is mounted a support table 40 and an operating handle 12. As best shown in FIG. 6 the base member 11 bas a pair of spaced, upstanding lugs 13, and a pivot pin 14, the respective ends of which are received through said lugs 13. The pin also passes through a bore in a generally cylindrical end part 15 of the operating handle 12, thereby pivotally to connect the handle to the base member 11, so that with the base member 11 standing on work surface WT, the operating handle 12 can be pivotally moved towards and away from it.

The handle 12 carries a cutting assembly CA which includes a cutting blade 38 having a downwardly facing cutting edge CE. Due to the pivotal connection between the handle 12 and base 11, the handle 12 is constrained to move within a plane of movement PM (FIG. 11) between an upper limit of reciprocal movement (as seen in FIG. 1) and a lowermost limit of reciprocal movement (as seen in FIG. 4).

The base member 11, support table 40 and the operating handle 12 are preferably plastics mouldings. Preferably as shown in FIGS. 4 and 5, the base member 11 is generally in the form of a hollow shell having side walls 11b, a top wall 11c and various strengthening ribs 11a.

Preferably the end faces of the side wall 11b and ribs 11a lie in a common plane to define a bottom support surface 16 which, in use, stands in face to face contact with the work surface WT. This provides the base member 11 with a rigid structure which is able to transfer loadings applied upon the top wall 11c directly onto the work surface WT.

In order to provide the cutting device with stability during operation, i.e. to prevent it from tipping from side to side (as viewed in FIG. 11), the base member 11 is chosen to be sufficiently wide as to extend laterally from the plane of movement PM by a predetermined amount.

Adjacent the lugs 13, the upper surface of the base member 11 is recessed, as best shown in FIG. 4 to define a recessed portion 11d which defines a flat support surface 17. The side of this portion 11d remote from the lugs 13 defines at its junction with the remaining upper surface of the base member 11 an arcuate upstanding surface 18. Correspondingly at the lugs, the junction with the flat portion is defined by a short central upstanding arcuate surface 19 from opposite sides of which extend respectively upstanding straight side surfaces 20, 21 which extend rearwardly at an angle which is generally at 45° to a plane which is transverse to the length of the base member 11.

As shown best in FIG. 4, a blind circular bore 22 extends downwardly through the recessed portion 11d in front of the surface 19, with the centre of the respective circles of which the surfaces 18 and 19 are part being the centre of the bore 22. The support table 40 includes a depending shaft portion 42 which is rotatably received in bore 22 so as to pivotally connect the table 40 to the base member 11.

Disposed centrally within base member 11 at the opposite side of the bore 22 from the surface 19 is a rectangular slot 23 which extends centrally between the opposite tapering sides of the rear end of the base member 11, this slot extending across the junction surface 18 between the recessed and unrecessed portions and terminating in a shallow finger depression 24. Fitted in this slot is a sprung locking lever 25, preferably of plastics material, which is operable to locate the table 40 at desired rotary positions relative to base member 11. The lever is formed with a projection 26 positioned in the part of the slot which lies in the recessed portion 11d directly adjacent the surface 18, as shown in FIGS. 4 and 6. The spring force on the lever 25 can be of any suitable form, and it is envisaged that the lever may be integrally formed with the base member 11 so as to be resiliently sprung to its upper position shown in FIG. 4 without any separate sprig component.

In the normal biased state of the lever 25, an end part of the lever lies in the part of the slot in the recessed portion 11d so as to be generally flush with the support surface 17 formed thereby. The projection 26 is between this part of the lever and a further part which lies in the part of the slot leading to the depression 24, this further lever part of the lever also lying generally flush with its surrounding surface. An operating knob 28 formed integrally on the end of the lever projects upwardly from the surface surrounding the depression 24, so as to be manually operable for depression by an operator's finger when it is wished to depress the lever against its spring bias. On release of downwards pressure on the knob 28, the lever will automatically return under its bias to the position shown in FIG. 4.

The end of the lever 25 opposite knob 28 is provided with a depending anchor portion 25a which is wedgingly received in a bore 25b formed in the base member 11. The anchor portion 25a fixedly connects the lever 25 to the base member 11 and enables the lever 25 to resiliently deflect along its length when the knob 28 is depressed.

The support table 40 has a flat body portion having a flat upper support surface SF upon which trim 10 to be cut is seated. The body portion of table 40 also has a flat bottom bearing surface BS which lies in face to face sliding contact with support surface 17 of recess 11d. Accordingly load forces applied downwardly upon the support surface SF are directly transferred to the base member 11 thereby enabling the support surface SF to present a rigid reaction surface for co-operation with blade 38. The body portion of table 40 is of generally semi-cylindrical form and has along its straight edge an upstanding guide ledge 41. In use, the trim 10 is seated upon the support surface SF whilst also in abutment with the guide ledge 41. The guide ledge 41 thus locates the longitudinal axis of the trim 10 at a predetermined position relative to the rotary position of the table 40 and also enables the trim 10 to be moved longitudinally to a desired position.

The bottom surface BS of the table body portion is provided with a series of slots 45 spaced about the semi-circular peripheral edge 41a of the table body portion, each slot 45 being shaped to receive projection 26 of lever 25 without play so as to rigidly hold the table 40 at selected rotary positions. Conveniently seven slots 45 are provided spaced about edge 41a so as to selectively retain the table 40 at rotary positions whereat the straight guide ledge 41 extends longitudinally at desired angles relative to the movable plane PM, the angular positions are preferably spaced by increments of 15° with a central slot 45 positioning the guide ledge at 90° relative to plane PM and outermost slots 45 positioning the ledge at +45° and −45° respectively relative to the plane PM.

Preferably the upper surface SF of table 40 is provided with a series of radially extending grooves 43 which are angularly spaced from one another to correspond to the rotary positions determined by slots 45. The grooves 43 are each of a sufficient length to receive the length of the cutting edge CE of blade 38.

Accordingly, as seen in FIG. 4, when the handle 12 is located at its lowermost position the cutting edge CE is located in a groove 43 and so is positioned beneath the surface SF of table 40. This enables the cutting edge CE of blade 38 to pass completely through trim 10 and thereby provide a clean cut.

Preferably the handle 12 is provided with a downwardly extending projection 12a which engages the table 40 and/or upper surface of the base member 11 to act as a stop and thereby define the lowermost limit position of the handle 12. This enables the cutting edge CE to be forced through an edging trim 10 and into a groove 43 without causing the cutting edge CE to penetrate into the bottom of the groove 43 by more than a predetermined amount. Conveniently, the terminal end of grooves 43 are each provided with a recess 44 in which indicia are preferably located in order to indicate to the operative the rotary angle of the table 40 relative to the plane of movement PM.

FIG. 2 shows the table 40 in its central position, so that a strip of trim 10 as shown in FIG. 2, when placed against the ledge 41 will be cut at 90° when the handle is brought down towards the base member 11. The 90° cut is clearly shown in FIG. 2, the operating handle then being lifted to allow release of the two parts of the cut trim. In contrast, FIG. 3 shows the member adjusted through 45° from its FIG. 2 position so that with the trim again held against the ledge 41, and the operating handle 12 brought down to effect cutting, the cut will now be at 45° to the longitudinal extent of the trim, again as clearly shown in FIG. 3. It will thus be appreciated that with this stepwise adjustment, cuts can be made at 45°, 60°, 75°, and 90°.

The first embodiment of the invention (as shown in FIGS. 1 to 10) primarily differs from the second embodiment (as show in FIGS. 12 to 19) in that a different cutting assembly CA and modified table 40 is provided.

In the first embodiment, the operating handle 12 has, in each of its sides, a rectangular recess 30 which is open at the underside of the handle 12. In each recess 30 is fitted a die-cast element 31 which has a generally rectangular part 32 received in the main part of the recess in the side of the operating handle, and an integral extension 33 in the form of an outwardly facing concavely curved leg part. Each element 31 has at its opposite upper corners respective bores therethrough and headed posidrive screws 34 are received through the aligned bores in the two elements 31 respectively, the screws passing through respective bores in the part of the operating handle 12 received between the elements 31, which are shown schematically in their connected state in FIG. 10. Respective nuts 35 are received on the ends of the screws 34 to secure the elements 31 in position together at respective opposite sides of the operating handle.

As shown in FIGS. 7 to 10, the interior of each leg part 33 is provided with projections 36 to be received in complementary recesses 37 in a conventional disposable cutting blade 38, i.e. of the kind used in a Stanley™ knife. Moreover below the projections 36 the elements 31 have pegs 39 to engage the blade, the projections and pegs ensuing that the blade is accurately and securely fixed between the two die-cast elements 31.

Other features of both embodiments of the cutting device are to be noted. Firstly it can be seen particularly from FIGS. 5 and 6 that at its extreme front end, the base member 11 is formed with an integral extension through which is provided a slot 46 for hanging the article. In particular as a slot 46 is a so-called ‘Euro-slot’ it can be used with conventional shop fittings to display the item for sale, with or without associated packaging also providing a hanging slot. Secondly as best shown in FIGS. 1 and 4, the rear end of the operating handle is provided wit a safety catch 47 which, at its lower end can be engaged with a rear end of the base member 11, for example as shown in dashed lines in FIG. 4, so as to lock the base 11 and handle 12 safely together during storage, this safety catch ensuing that the blade is not exposed during such storage or transport.

If desired, a safety guard 500 (FIG. 12) can be provided either side of the blade.

Optionally, a hold-down safety clip (not shown) which can be located in slots 49 of table 40 and in order to hold a trim 10 in place during the cutting process.

A further, optional feature is shown in FIG. 5, by way of feet 50 on the underside of the base member 11.

It will be appreciated that with suitable locking means, it may be possible to provide for stepless adjustability of the member 40.

In the second embodiment, (FIGS. 12 to 19) the cutting assembly CA is in the form of a cassette 150 which includes a cassette body 151 and a STANLEY™ type blade 38 fixedly held within body 151. The cassette 150 is a push-fit within a recess 130 formed in the handle 12 so as to enable the cassette 150 to be easily removed for replacement of blade 38.

As seen more clearly in FIGS. 17, 18, the sides of the recess 130 are each provided with longitudinally extending location ribs 132. The cassette body 151 is preferably moulded from a plastics material and is generally of U-shaped form having a pair of legs 152 depending from a central body portion 153. The cassette body 151 thereby extends around the periphery of the blade 38 on three sides leaving the cutting edge CE and the body of the blade exposed.

A groove 155 extends longitudinally along the outer face of each leg 152, each groove 155 being sized to receive a respective location rib 132 without play. The respective location ribs 132 and grooves 155 thereby co-operate to accurately position the blade 38 relative to the handle 12 and also resist twisting of the blade 38 relative to the handle during use.

In order to detachably locate the cassette 150 within the recess 130, the handle 12 is provided with a pair of downwardly depending flanges 135 which are laterally spaced from one another.

The cassette body portion 153 is provided with a pair of recesses 156 located on opposite sides of the body portion 153 and arranged to receive a respective flange 135.

The opposed faces 135a, 156a of each pair of respectively co-operating flanges 135 and recesses 156 are provided with respective detent formations 160, preferably in the form of projections 161 and recesses 162 which inter-engage to resist separation of the cassette 150 from the handle 12 when the cassette 150 is fully received within the recess 130. Preferably, in order to create a greater resistance to prevent withdrawal of the cassette 150 from recess 130, the pairs of co-operating flanges 135 and recesses 156 also wedgingly inter-react. This is preferably achieved by suitably tapering the opposed faces 135a, 156a.

Accordingly, the cassette 150 when fully inserted in the handle 12 is fixedly located and accurately positioned.

In order to remove a cassette 150 from the handle 12 for blade replacement, it is necessary to use a cassette removal tool 200 (FIGS. 13 to 15).

The tool 200, which is preferably moulded from a plastics material, includes an elongate body 201 having at one end a handle 205 and having at its opposite end a cassette engaging formation 207.

The formation 207 includes a pair of wall portions 208 which are spaced apart to define a gap 209. The gap 209 is chosen to be of a width which is the same as the thickness of blade 38. The end wall of each wall portion 208 facing the handle 205 is provided with a projection 211 which is engageable with a recess 220 formed on the inside wall of leg 152.

The body 201 further includes a downwardly extending projection 225 and rib 226. The table 40 in the second embodiment has elongate slots 144 formed in the upper surface SF which slidingly receive projection 225. The rib 226 is sized and shaped so as to be slidingly received within a groove 43.

In use, the tool 200 is positioned on table 40 with its projection 225 and rib 226 located within a slot 144 and associated groove 43.

The handle 12 is lowered so as to move the blade 38 into gap 209. When the handle 12 has been fully lowered (as seen in FIG. 15), the tool 200 is manually pulled longitudinally (in direction of arrow A) to bring the projection 211 into engagement with recess 220.

The operative then raises handle 12 whilst holding the tool 200 in contact with table 40. This action causes the tool 200 to exert a pulling force onto the cassette 150 at one end thereof and so also imports a twisting action onto the cassette 150. Accordingly, a relatively high pulling force is exerted to remove the cassette 150 from the recess 130.

Re-insertion of a cassette 150 is achieved by reversing the above described extraction process.

Preferably as illustrated in FIGS. 19a to 19c the cassette body 151 comprises a pair of half body portions 251, 252 which inter-engages to form an assembled body 151 having a blade 38 sandwiched therebetween.

Each half body portion 251, 252 includes a recess 255 on each leg portion which on assembly define grooves 155.

In addition each leg portion is provided with a recess 220.

Female half body portion 251 includes a recessed seat 350 which is shaped to provide a positive location for blade 38. At the terminal end of each leg portion of half body portion 251 there is provided a housing 351 for the reception of a tongue 451 formed at the terminal end of each leg portion of the male half body portion 252.

The female portion 251 is also provided with apertures 352 for the reception of latching tongues 452 formed on the male portion 252.

To assemble a cassette 150, a blade 38 is placed in the recessed seat 350 of the female portion 251 (FIG. 19a). The male portion 252 is then positioned over the female portion 251 and the tongues 451 are inserted into respective housings 351 (FIG. 19b). The male portion 252 is then pivoted about housings 351 in order to introduce the latching tongues 452 into the apertures 352 (FIG. 19c). Once located wit apertures 352, the latching tongues 452 co-operate therewith to resist withdrawal of the tongues 452 from apertures 352.

It will be noted from FIG. 19c, that when the cassette 150 is located in the recess 130 of the handle, flanges 135 of the handle 12 will be located in recesses 156 located on opposite sides of the cassette body 151. Accordingly, in use, flanges 135 co-operate with one another to assist in resisting separation of the female and male portions 251, 252.

Conveniently the cassette body 151 is symmetrical with respect to the construction of its legs 152 and body 153 so that it may be inserted into the recess 130 with one or other of its legs 152 closest to the pivot 13.

It will be appreciated that the table 40 for both embodiments is designed to have a width greater than the width of the base member 11 so that in all rotary positions of the table 40 relative to the base member 11 the table has an overhanging portion OP.

Preferably the base member 11 is sized so as to space the overhanging portion OP above the work surface WT by a height H which is sufficient to enable an operative to locate his fingers beneath the overhanging portion OP whilst the base member 11 is seated on work surface WT.

As shown in FIGS. 2 and 3, this enables the operative to grip the overhanging portion OP and also grip the trim 10 to hold it in position during the cuing operation (whilst positioning the handle of the operative in a spaced relationship with respect to the place of movement PM of the blade 38).

1. A cutting device for producing an end cut in an elongate article, the cutting device including a handle movably mounted on a base and a support table mounted on said base, the support table having an upwardly facing support surface on which an article to be cut may be mounted, and a cutting assembly including a disposable cutting blade, the cutting assembly being detachably mounted on said handle to enable replacement of said blade.

2. A cutting device according to claim 1 wherein said cutting blade has a downwardly facing cutting edge, and said support table has an upwardly facing support face upon which said elongate article which is to be cut may be seated and said support base being adapted for standing on an upwardly facing flat support work surface, the handle being movably mounted relative to the support table for displacement within a plane of movement which is located at a desired angle to said support face of the support table, the handle being movable between a first limit of reciprocal movement whereat the cutting blade is spaced from said support table to enable said article to be positioned on said support face in readiness for being cut and a second limit of reciprocal movement whereat the cutting blade is positioned adjacent said support table with its cutting edge located on or beneath said support face, said support table having an overhanging portion which projects laterally from said plane of movement and beyond said base, the overhanging portion being spaced from said work surface by said base to define a hand grip to enable an article to be cut to be manually gripped and held in position whilst said handle is moved from its first to its second limit of reciprocal movement.

3. A device according to claim 1 or 2 wherein the table is rotatably mounted on said base and is adapted to be selectively located in any one of a plurality of predetermined rotary positions

4. A device according to claim 3 wherein said table has a bottom bearing face in face to face sliding contact with an upper face on said base.

5. A device according to any preceding claim wherein said cutting assembly comprises a cassette detachably secured within a recess formed in said handle, said cassette having a body extending about the periphery of said blade and within which said blade is fixedly mounted.

6. A device according to claim 5 wherein said cassette body includes location formations which co-operate with location formations on said handle to accurately position said cassette body within said recess of the handle.

7. A device according to claim 6 wherein the cassette body comprises two half body portions which are inter-engageable to define said cassette body.

8. A device according to any preceding claim wherein said handle, base and table are plastics mouldings.
